(19) United States
(12) Patent Application Publication
(10) Pub. No.: US 2015/0241864 A1
(43) Pub. Date: Aug. 27, 2015

(54) ZERO SEQUENCE CURRENT CONTROL APPARATUS AND METHOD FOR PARALLEL POWER CONVERTERS

(71) Applicant: Chung-Shan Institute of Science and Technology, Armaments Bureau, M.N.D, Taoyuan County (TW)

(72) Inventors: Kun-Feng Chen, Taoyuan County (TW); Yu-Min Liao, Taoyuan County (TW); Kuo-Kuang Jen, Taoyuan County (TW); Guo-Huei You, Taoyuan County (TW)

(73) Assignee: Chung-Shan Institute of Science and Technology, Armaments Bureau, M.N.D, Taoyuan County (TW)

(21) Appl. No.: 14/186,574

(22) Filed: Feb. 21, 2014

(51) Int. Cl. G05B 19/18

(52) U.S. Cl. CPC G05B 19/188; G05B 2219/37282

(57) ABSTRACT

A zero sequence current control apparatus and a zero sequence current control method for parallel power converters are disclosed to overcome the issue of having uniform output power for the parallel operation of a plurality of single module voltage control power converters, and an eCAN BUS acts as a communication interface for transmitting instructions, so that when each of the single module voltage control power converters is operated in the parallel operation, the effect of outputting uniform voltage, current and power can be achieved.

### BACKGROUND OF THE INVENTION

1. Field of Invention

The present invention relates to a zero sequence current control apparatus and method for parallel power converters, in particular to the zero sequence current control apparatus and method capable of modulating and uniformly allocating an output power of a plurality of single module voltage control power converters in a parallel operation and outputting uniform voltage, current and power from each of the single module voltage control power converters during the parallel operation.

2. Description of Related Art

As the capacity of power conversion (DC-to-AC conversion) becomes increasingly larger, and power switch components of a power converter are limited by the resistance of voltage and current, the output capacity of a single power converter is unable to meet the requirements. In recent years, several power converters are generally connected in parallel to one another to increase the capacity of the power conversion, but the parallel operation may have the issues of output voltage phase, current phase and frequency synchronization control, which are the synchronous signal control issues. If current is not controlled properly, then the circulation problem must result, and thus controlling synchronous signals and overcoming the circulation problem are the problems of the power converter that require solutions in a parallel operation. In general, the manufacture of the power converters is mainly divided into two types, respectively a power converter with an independent power supply and a power converter with a utility power network, and their rated power is the capacity for single converters. If a load side requires high power and large capacity, the parallel operation of the power converters will be adopted. Regardless of the power converters with independent power supply or utility power network, both require a special control mechanism. When the power converters in parallel with each other are operated, the most commonly used method involves the synchronous signal control method and a host/slave hardware detection control method. In these methods, the standalone operation and the parallel operation have different control mechanism, and thus it is an additional burden to manufacturers to produce two different models.

Therefore, it is a main subject for related manufacturers to develop and provide a control mechanism for standalone power converters or parallelly operated power converters.

### SUMMARY OF THE INVENTION

Therefore, it is a primary objective of the present invention to provide a zero sequence current control apparatus and method for parallel power converters, in particular to the zero sequence current control apparatus and method capable of modulating and uniformly allocating an output power of a plurality of single module voltage control power converters in a parallel operation and outputting uniform voltage, current and power from each of the single module voltage control power converters during the parallel operation.

To achieve the aforementioned and other objectives, the present invention provides a zero sequence current control apparatus of parallel power converters, comprising: a control and management system, including an automatic allocation device and a control device; a plurality of modules;

a local area network, having an input terminal electrically coupled to the automatic allocation device and the control device, and an output terminal communicated with the modules; wherein, the automatic allocation device locates a host module according to a boot registration sequence of each module, and converts other modules into slave modules, and the automatic allocation device allocates an output voltage, an output current and an output power of the host module and the slave modules.

To achieve the aforementioned and other objectives, the present invention further provides a zero sequence current control method for parallel power converters, comprising the steps of: initializing a control and management system; combining a first-group single module voltage control power converter into the system; registering the first-group single module voltage control power converter; operating the first-group single module voltage control power converter independently; writing numeric values of the voltage, current and power of the first-group single module voltage control power converter into the eCAN BUS; and determining whether the writing of numeric values into the eCAN BUS is completed.

### BRIEF DESCRIPTION OF THE DRAWINGS

The technical characteristics and objectives of the present invention can be further understood by the following detailed description of preferred embodiments and related drawings in which:

FIG. 1 is a schematic view of a zero sequence current control apparatus for parallel power converters of the present invention;

FIG. 2 is a schematic view of a parallel single module voltage control power converter installed in an automatic allocation device of the present invention;

FIGS. 3A and 3B are flowchart (1) and flowchart (2) of a zero sequence current control method for parallel power converters of the present invention respectively; and

FIG. 4 is a schematic view of a mailbox of a zero sequence current control apparatus for parallel power converters of the present invention.

### DETAILED DESCRIPTION OF THE INVENTION

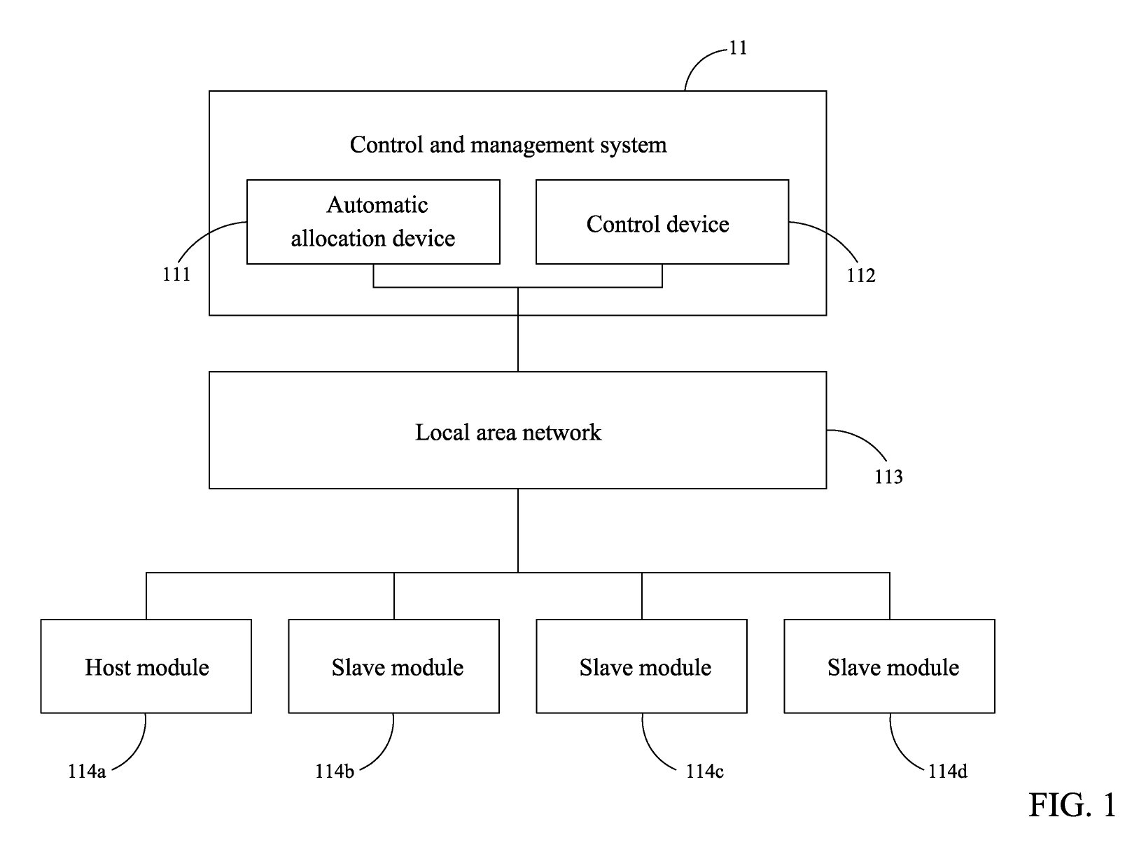

With reference to FIG. 1 for a zero sequence current control apparatus for parallel power converters in accordance with the present invention, the zero sequence current control apparatus comprises a control and management system 11, and the control and management system 11 is comprised of an automatic allocation device 111, a control device 112, a local area network 113 and a plurality of modules 114.

The local area network 113 has an input terminal electrically coupled to the automatic allocation device 111 and the control device 112, such that an output terminal of the control and management system 11 can communicate with the modules 114. Wherein, the automatic allocation device 111 locates a host module 114a according to a boot registration sequence of each module 114 and converts other modules into slave module (such as 114b, 114c, and 114d), and the automatic allocation device 111 allocates an output voltage, an output current and an output power to the host module 114a and the slave modules 114b, 114c, 114d.

In addition, the control device 112 sends out a control instruction to write numeric values of the output voltage, output current and output power of the host module 114a and the slave modules 114b, 114c, 114d into the local area network 113, and the local area network 113 is an enhanced controller local area network (eCAN BUS).

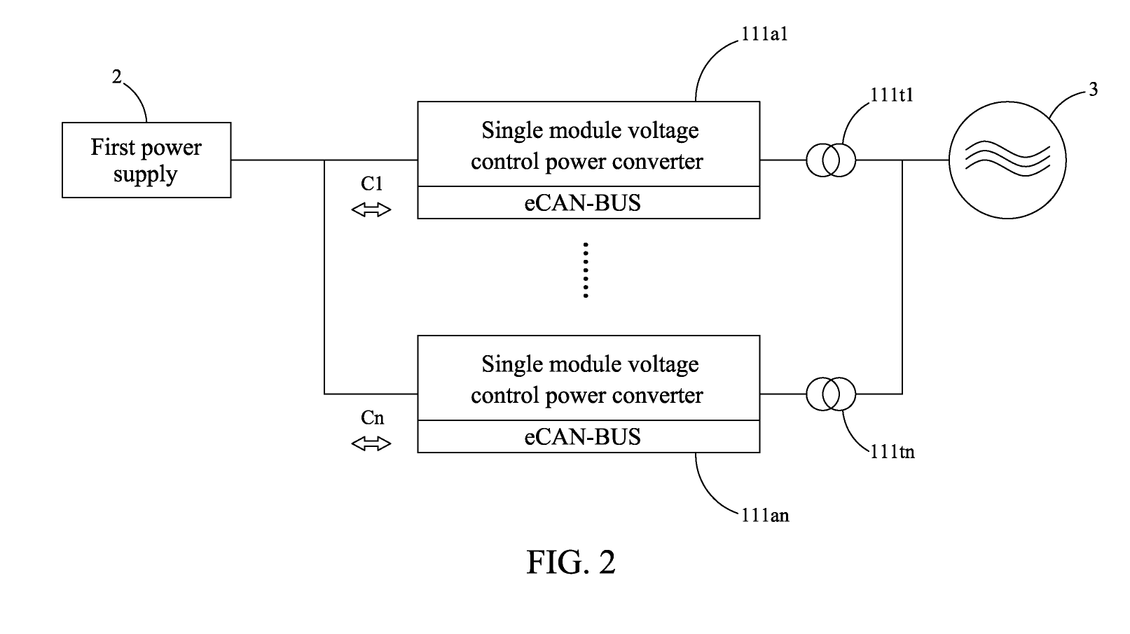

With reference to FIG. 2 for the parallel single module voltage control power converters installed in the automatic allocation device 111 of the present invention, the automatic allocation device 111 comprises a plurality of single module voltage control power converters 111a1, 111a2, 111a3 . . . 111an and a plurality of isolation transformers 111t1, 111t2, 111t3 . . . 111tn, and the single module voltage control power converters 111a1, 111a2, 111a3 . . . 111an have an input terminal electrically coupled to a first power supply 2, and an output terminal electrically coupled to an input terminal of the isolation transformers 111t1, 111t2, 111t3 . . . 111tn, and the output terminal of the isolation transformers 111t1, 111t2, 111t3 . . . 111tn is electrically coupled to a second power supply 3. The first power supply 2 is a DC power supply network, and the second power supply 3 is an AC power supply network.

Since the present invention transmits an instruction from the eCAN BUS to allocate the power and suppresses the use of the zero sequence circulation, each system registration sequence is provided for determining the host module and slave modules. Each single module voltage control power converter 111a1, 111a2, 111a3 . . . 111an has the eCAN BUS installed therein and provided for communication through the eCAN BUS to confirm the relation between the host module and the slave modules of each system, so as to allocate the power and suppress the zero sequence circulation.

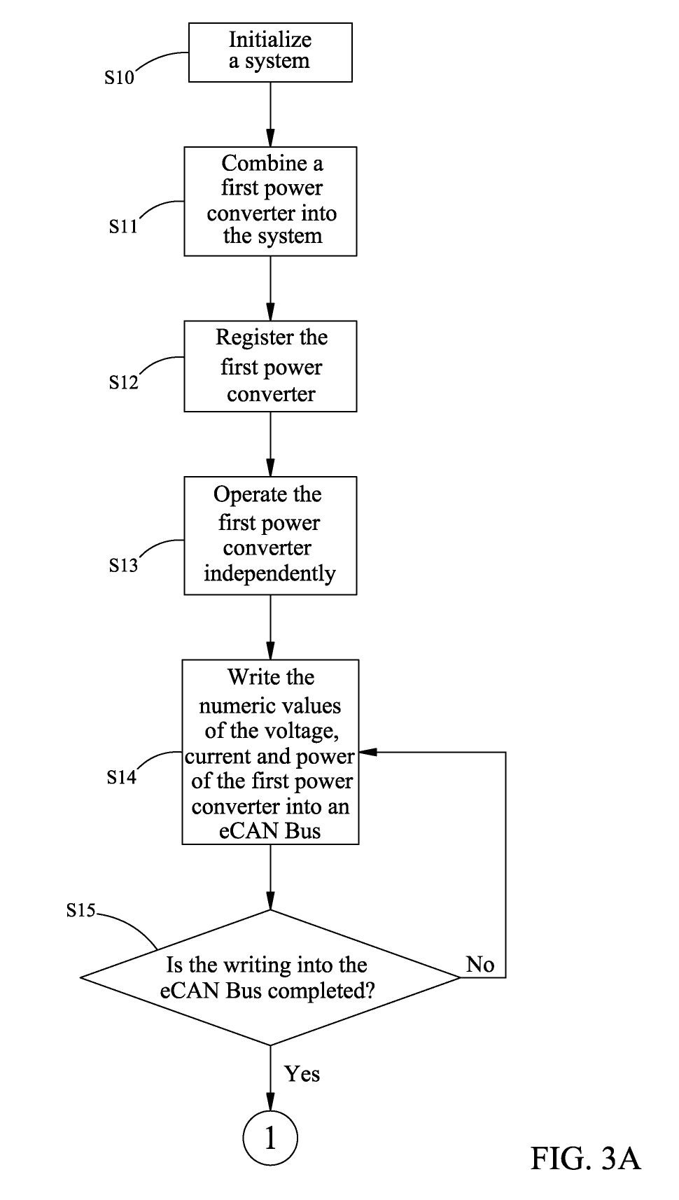

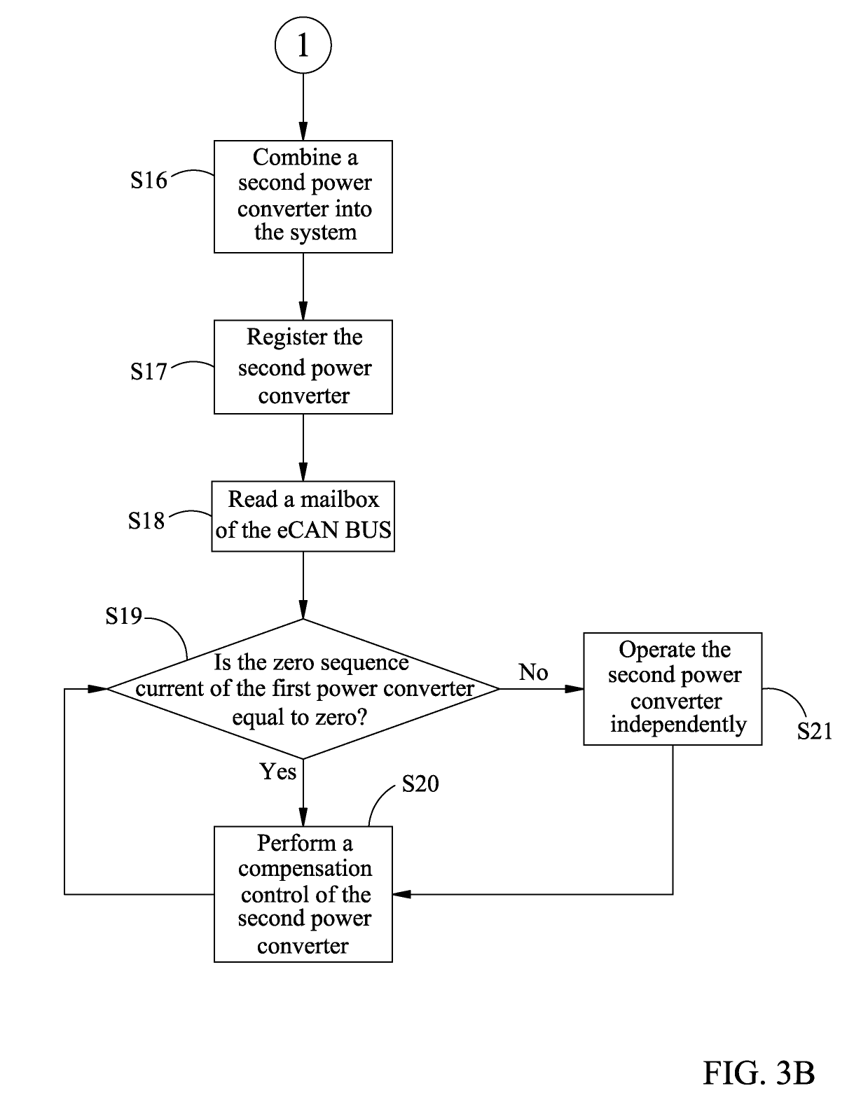

With reference to FIGS. 3A and 3B for a zero sequence current control method for parallel power converters of the present invention, the method comprises the following steps:

S10: Initialize the control and management system 11.

S11: Combine a first-group single module voltage control power converter 111a1 into the system.

S12: Register the first-group single module voltage control power converter 111a1.

S13: Operate the first-group single module voltage control power converter 111a1 independently.

S14: Write numeric values of the voltage, current and power of the first-group single module voltage control power converter 111a1 into the eCAN BUS.

S15: Determine whether the writing into the eCAN BUS is completed. If yes, then go to S16, or else return to S14.

S16: Combine a second-group single module voltage control power converter 111a2 into the system.

S17: Register the second-group single module voltage control power converter 111a2.

S18: Read a mailbox of the eCAN BUS.

S19: Detect and determine whether a zero sequence current of the first-group single module voltage control power converter 111a1 is zero. If yes, then go to S20, or else go to S21.

S20: Operate the second-group single module voltage control power converter 111a2 independently, and then return to S19.

S21: Perform a compensation control of the second-group single module voltage control power converter 111a2, and then return to Step S20.

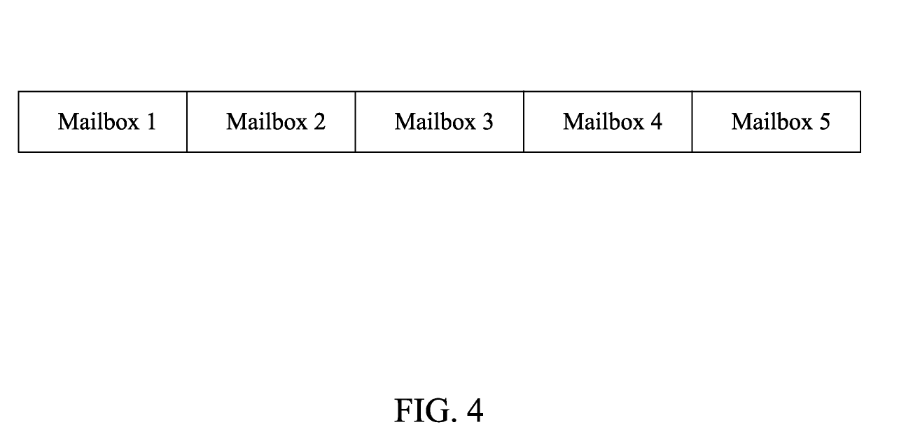

With reference to FIG. 4 for a mailbox of a zero sequence current control apparatus for parallel power converters of the present invention, the functions of the mailbox are defined according to the functional requirements of the instructions, and the mailbox is defined as follows:

(1) Mailbox 1 relates to a host/slave system registration sequence. Wherein, the host has the station number 1, and the slaves have the station number starting from 2. The initial station number 0 may be provided for defining the control device 112, if needed.

(2) Mailbox 2 relates to the status of a host/slave. 0 refers to an interrupt, and 1 refers to an operation.

(3) Mailbox 3 shows the power of a single module voltage control power converter.

(4) Mailbox 4 shows the voltage of a single module voltage control power converter.

(5) Mailbox 5 shows the current of a single module voltage control power converter.

The zero sequence current control apparatus for parallel power converters of the present invention may set the communication structure and instruction mode of a plurality of single module voltage control power converters 111a1, 111a2, 111a3 . . . 111an primarily for setting the zero sequence circulation of the total output to zero, and suppressing the circulation, so that the current allocated for the host and slaves can be uniform to prevent losses due to any overload of the single module voltage control power converters 111a1 , 111a2, 111a3 . . . 111an and accomplish the power modulation among the single module voltage control power converters 111a1, 111a2, 111a3 . . . 111an to facilitate the control side to adjust the total output power successfully and adjust the total output power according to the variable loads.

The automatic allocation device 111 of the present invention uses the eCAN BUS as a communication interface to execute the parallel instruction of dividing the single module voltage control power converters 111a1, 111a2, 111a3 . . . 111an into the host and slaves according to the boot registration sequence, and an instruction is transmitted from the host to the slaves through the eCAN BUS, so that the host and slaves can perform power modulation simultaneously, and the power can be controlled and modulated according to the quantity of registered slaves.

In summation, the zero sequence current control apparatus and method for parallel power converters of the present invention can overcome the problem of modulating and allocating output power to each of the single module voltage control power converter 111a1, 111a2, 111a3 . . . 111an in a parallel operation and adopt the eCAN BUS as a communication interface for transmitting instruction, so that the uniform output voltage, current and power of each single module voltage control power converter 111a1, 111a2, 111a3 . . . 111 can be achieved in the parallel operation.

In summation of the description above, the present invention improves over the prior art and complies with the patent application requirements, and thus is duly filed for patent application.

What is claimed is:

1. A zero sequence current control apparatus of parallel power converters, comprising:
a control and management system, including an automatic allocation device and a control device;
a plurality of modules;
a local area network, having an input terminal electrically coupled to the automatic allocation device and the control device, and an output terminal communicated with the modules;
wherein, the automatic allocation device locates a host module according to a boot registration sequence of each module, and converts other modules into slave modules, and the automatic allocation device allocates an output voltage, an output current and an output power of the host module and the slave modules.

2. The zero sequence current control apparatus of parallel power converters according to claim 1, wherein the control device and the slave modules send out a control instruction to write numeric values of the output voltage, output current and output power of the host module into the local area network.

3. The zero sequence current control apparatus of parallel power converters according to claim 1, wherein the local area network is an enhanced controller local area network.

4. The zero sequence current control apparatus of parallel power converters according to claim 1, wherein the automatic allocation device comprises:
a plurality of single module voltage control power converters, having an input terminal electrically coupled to a first power supply; and
a plurality of isolation transformers, having an input terminal electrically coupled to an output terminal of the single module voltage control power converters.

5. The zero sequence current control apparatus of parallel power converters according to claim 4, wherein the isolation transformers have an output terminal electrically coupled to a second power supply.

6. The zero sequence current control apparatus of parallel power converters according to claim 5, wherein the second power supply is an alternate current (AC) power supply network.

7. The zero sequence current control apparatus of parallel power converters according to claim 4, wherein the first power supply is a direct current (DC) power supply network.

8. A zero sequence current control method for parallel power converters, comprising the steps of:
initializing a control and management system;
combining a first-group single module voltage control power converter into the system;
registering the first-group single module voltage control power converter;
operating the first-group single module voltage control power converter independently;
writing numeric values of the voltage, current and power of the first-group single module voltage control power converter into the eCAN BUS; and
determining whether the writing of numeric values into the eCAN BUS is completed.

9. The zero sequence current control method for parallel power converters according to claim 8, further comprising the steps of:
combining a second-group single module voltage control power converter into the system;
registering the second-group single module voltage control power converter;
read a mailbox of the eCAN BUS;
detecting whether the zero sequence current of the first-group single module voltage control power converter is zero;
operating the second-group single module voltage control power converter independently; and
performing a compensation control of the second-group single module voltage control power converter.
